(19) United States
(12) Patent Application Publication
(10) Pub. No.: US 2024/0163982 A1
(43) Pub. Date: May 16, 2024

(54) ELECTRIC POWER SUPPLY APPARATUS

(71) Applicant: DANIELI AUTOMATION S.P.A., PASIAN DI PRATO (IT)

(72) Inventors: Antonello MORDEGLIA, BANGKOK (TH); Andrea POLO, SAN GIOVANNI AL NATISONE (IT)

(21) Appl. No.: 18/552,735

(22) PCT Filed: Mar. 29, 2022
(86) PCT No.: PCT/IT2022/050072

§ 371 Date: Sep. 27, 2023

(30) Foreign Application Priority Data
Mar. 30, 2021 (IT) 102021000007892

(51) Int. Cl. H05B 7/144; H02M 3/155; H02M 7/04

(52) U.S. Cl. CPC H05B 7/144; H02M 3/155; H02M 7/04

(57) ABSTRACT

An electric power supply apparatus for a direct current user device includes an electric power supply supplying a mains voltage and a mains current and a static power converter to transform a direct electric voltage into a direct electric voltage of a different value. The static power converter is connected to the electric power supply by a respective input connection circuit and to the user device by a respective output connection circuit.

### FIELD OF THE INVENTION

The present invention concerns an electric power supply apparatus for a direct current user device, in particular an electric furnace for iron and steel applications for the production of steel, or for other fields for working metal or glass materials, or similar or comparable materials.

The power supply apparatus is in particular suitable for transporting electrical energy, supplied by electrical energy supply means, to the user device by means of electric power supply lines, reducing load losses to a minimum.

### BACKGROUND OF THE INVENTION

As is known, electric furnaces for iron and steel applications require an efficient electric power supply system that provides high power and high currents.

Electric power supply systems normally provide an energy source, for example an electricity grid, which is connected to the user device by means of a power supply line. A series of electrical devices are provided along the power supply line, that is, the power supply line provides a series of intermediate segments that connect the electrical apparatuses between the electricity grid and the user device.

The connections of the known type between the energy source, the user device and the intermediate segments are made of conductive materials; in particular, most of the power lines are made of cables in copper, aluminum or other metal alloys.

In order to transport large currents, it is known to use cables with a large section, since these sections are sized according to known laws in electrical engineering systems. These cables can therefore reach sections with diameters of up to 200-400 mm each, connected together in parallel so as to be able to transport thousands of amperes, with a consequent increase in costs, weights and losses from the point of view of efficiency in energy transmission.

It is also known that the convenience of transporting electrical energy increases as voltage increases. The loss of energy in an electrical transport line is mainly due to losses due to the Joule effect, with the generation of heat caused by the flow of electric current.

Since the power transferred by the line is equal to the product of the voltage by the current, it can be understood that, given the same power, it is sufficient to increase the voltage to reduce the current and therefore the losses. The transport of energy generally takes place in alternating current (AC), except in specific situations, or applications, where very high direct current voltages (DC) and consequent low direct currents are used, which allow to considerably reduce the losses due to the Joule effect.

However, the use of high voltages to prevent losses during the transport of energy has limits, mainly due to the problem of cable insulation and the intrinsic safety of the system in the event of failure.

In the direct current power lines for electric furnaces, or in any case for users that require high operating currents, it is customary to connect the electricity grid to its own HV/MV transformation substation, which can be a few hundred meters away from the final user.

Normally, the substation is then connected, by means of an additional MV/MV (Medium Voltage/Medium Voltage) step-down adaptation transformer, to the power supply devices of the user device, that is, of the electric furnace.

For example, user devices are known which comprise a rectifier device to convert the electric voltage in alternating current supplied by the electricity grid into an electric voltage in direct current, and a static power converter to regulate the voltage value to be supplied to the load. These power supply devices are typically a few tens of meters from the user, so as to be able to provide the high currents while trying to contain the losses described above.

However, the need to provide this short distance between the energy sources, therefore the electricity grid and/or the substations or intermediate electrical apparatuses, the power supply devices and the user device, often turns out to be a very stringent constraint that risks being an obstacle if changes or renovations need to be made to existing lines and/or plants.

Document WO03/019986A2 discloses a direct current power supply device for an electric arc furnace.

Document EP2528180A2 discloses a method and a system for the transmission of energy in direct current.

There is therefore a need to perfect an electric power supply apparatus for a direct current user device which can overcome at least one of the disadvantages of the state of the art.

One purpose of the present invention is therefore to provide an electric power supply apparatus for iron and steel applications, and not only, which allows one or more user devices, including those with high energy absorption, to be connected to at least one source of electrical energy in an efficient and economical manner, and which limits the normal losses due to the transport of electrical energy on a power supply line, for example losses due to the Joule effect.

Another purpose of the present invention is to provide an electric power supply apparatus which is substantially free of constraints relating to the distance between the various components, and which allows, if necessary and effectively, to distance from each other the various electrical apparatuses of which it consists, for example in order to expand a steel plant, to install new components, or other.

Another purpose of the present invention is to provide an electric power supply apparatus which can be extremely variable and flexible, adaptable to requirements on each occasion.

Another purpose of the invention is to provide an electric power supply apparatus for a steel plant which can function at least partly independently from the public electricity grid, so as to reduce the energy supply costs and therefore the overall production costs, as well as free itself from any power outages of the grid itself.

The Applicant has devised, tested and embodied the present invention to overcome the shortcomings of the state of the art and to obtain these and other purposes and advantages.

### SUMMARY OF THE INVENTION

The present invention is set forth and characterized in the independent claim. The dependent claims describe other characteristics of the present invention or variants to the main inventive idea.

In accordance with the above purposes, an electric power supply apparatus for a user device according to the invention, in particular a direct current electric furnace for iron and steel applications, or for glass or metal processing applications, comprises electrical energy supply means supplying a supply voltage and a supply current, and at least one electric connection line between the electrical energy supply means and the user device, and a power converter configured to transform a direct electric voltage into a direct electric voltage of a different value; the power converter is connected to the electrical energy supply means by means of a respective input connection circuit, and to the user device by means of a respective output connection circuit.

According to one aspect of the present invention, at least one of either the input connection circuit and/or the output connection circuit comprises at least one segment of line made with a superconductor cable.

According to some embodiments, the power converter is a splitter device comprising an electronic switch that can be selectively commanded to open and close a connection circuit between a direct current circuit, or DC-link, and the user device, and a recirculation diode connected in series to said electronic switch and in anti-parallel to said user device.

The power converter can be of the static type and can also comprise an input capacitor connected in parallel to the rectifier device, and an output inductor connected on one side to the user device and on the other side in a node between the electronic switch and the diode.

According to some embodiments, the electrical energy supply means comprise an electricity grid which supplies electrical energy in alternating current, and the electric power supply apparatus comprises a rectifier device configured to transform the electrical energy in alternating current into electrical energy in direct current, the rectifier device being connected to the input connection circuit upstream of the power converter.

According to some embodiments, a transformer, for example a high voltage/medium voltage transformer, or a medium voltage/medium voltage transformer, can be provided upstream of the rectifier device. The transformer is able to transform the alternating electrical energy supplied by the electricity grid into alternating electric voltage and current that have suitable values different from the power supply values.

According to some embodiments, the segments of line of the input connection circuit, which connect the rectifier device and the power converter, are entirely made with superconductor cables, at least until upstream of the input capacitor.

According to other embodiments, the electrical energy supply means comprise at least one source of alternative energy, preferably of the renewable type, connected to the input connection circuit and configured to supply supply energy to the user device in addition, or as an alternative, to the electrical energy supplied by the supply electricity grid.

Thanks to the source of alternative energy, it is possible to power, at least partly, the user device independently of the electricity grid, and possibly allow an at least temporary disconnection of the user device from the electricity grid, or in any case reduce the supply of energy from the electricity grid as a function of the daily time frame, possibly limiting it to the times when it is least expensive.

According to some embodiments, the source of alternative energy can be selected from renewable solar, wind, or hydroelectric energy sources, or non-renewable energy sources, for example deriving from the combustion of fossil fuels, such as oil, coal, or gas.

The source of alternative energy can be advantageously connected to the static power converter in correspondence with a direct current circuit, or DC-link, upstream of an electronic switch.

Preferably, at least one segment of line that connects the source of alternative energy to the power converter is made with superconductor cables. This allows to position the source of alternative energy even very far from the user device, that is, from hundreds of meters up to a few tens of kilometers, and to transfer the electrical energy with substantially negligible losses, in particular in direct current. According to other embodiments, which can be combined with the other embodiments described here, at least one segment of line of the output connection circuit is made with a superconductor cable.

For example, it can be provided that the output connection circuit is entirely made with a superconductor cable up to the user device, or at least up to the point of connection with the output inductor.

A conductor cable of the traditional type can be provided between the output inductor and the user device.

According to some embodiments, all the segments of line of the power supply circuit in which a direct current passes can be made with superconductor cables.

Here and hereafter in the description, by “superconductor cable” we mean an electric cable made with semi-ceramic or ceramic materials, defined as HTS (High Temperature Superconductivity), or metal materials, defined as LTS (Low Temperature Superconductivity). These materials, if brought to a critical temperature, specific for each of them, have the characteristic of having a substantially zero resistance to the passage of current. In particular, the superconductor cables in question are cables defined as such according to the BCS (Bardeen-Cooper-Schrieffer) theory of superconductivity, ceramic- or metal-based, or salt-based.

Advantageously, by using one or more superconductor cables to create one or more of the segments of line, it is possible to produce an electric power supply apparatus that allows to efficiently connect at least one user device to electrical energy supply means, even a device with high energy absorption, also positioned at a certain distance from the electrical energy supply means, limiting normal losses due to the transport of electrical energy on a power supply line, for example due to the Joule effect.

Thanks to the use of a superconductor cable to create at least part of the connection circuits of the electric power supply apparatus, it is possible to separate and distance a first part and a second part of the electric power supply apparatus from each other by, for example, a few tens up to a few hundreds of meters, or even a few kilometers, with negligible losses.

In this way, it is possible to install a first part of the electric power supply apparatus, for example comprising the transformer and the rectifier device, in a first building, for example in proximity to the electricity grid, and a second part, comprising at least the output circuit, in a second building in which the user device is located.

The present electric power supply apparatus is therefore substantially free of constraints relating to the distance between the electrical energy supply means and the user device.

Furthermore, it is also free of constraints connected to the distance between the various components and electrical apparatuses, that is, it allows, if necessary and effectively, to provide an extremely variable and flexible distancing between the components of the electric power supply apparatus. This distancing may be necessary, for example, due to the needs of expanding a steel plant, installing new components, or other. This is also due to the fact that superconductor cables are particularly efficient in transporting direct electric current.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic view of an electric power supply apparatus according to some embodiments described here;

FIG. 2 is a schematic view of an electric power supply apparatus according to some variants;

FIG. 3 is a schematic view of an electric power supply apparatus according to other embodiments described here;

FIG. 4 shows a schematic graph of the trend of the input and output voltage to a power converter of the electric power supply apparatus of the present invention;

FIG. 5 is a schematic view of the electric power supply apparatus of FIG. 1 according to a variant;

FIG. 6 is a schematic view of the electric power supply apparatus of FIG. 2 according to a variant.

To facilitate comprehension, the same reference numbers have been used, where possible, to identify identical common elements in the drawings. It is understood that elements and characteristics of one embodiment can be conveniently combined, or incorporated, into other embodiments without further clarifications.

### DESCRIPTION OF SOME EMBODIMENTS

We will now refer in detail to the possible embodiments of the invention, of which one or more examples are shown in the attached drawings, by way of a non-limiting illustration. The phraseology and terminology used here is also for the purposes of providing non-limiting examples.

The embodiments described here with reference to the attached drawings concern an electrical energy supply apparatus 10 suitable to supply electrical energy to a user device 11, in particular an electric furnace 11 of a plant 20 for iron and steel applications, or for melting glass or other materials.

The electric furnace 11 can be, for example, a direct current electric arc furnace.

The electric power supply apparatus 10 comprises electrical energy supply means 12, suitable to supply electrical energy having predefined voltage, current and frequency values.

According to the embodiments described with reference to FIGS. 1-3 and 5-6, the electrical energy supply means 12 comprise an electricity grid 12A, for example a three-phase electricity grid, configured to supply electrical energy in alternating current, and the electric power supply apparatus 10 comprises connection means 13 for connection to the electricity grid 12A and means for connection to the electric furnace 11.

The electric power supply apparatus 10 comprises a rectifier device 14, connected to the electricity grid 12A, configured to transform the electric voltage in alternating current into electric voltage in direct current, and a static power converter 15 connected between the rectifier device 14 and the electric furnace 11.

The power converter 15 is configured to transform an input electric voltage Vin in direct current into an output electric voltage Vo in direct current of a different value.

The electric power supply apparatus 10 can also comprise a transformer 16 connected to the electricity grid 12A, upstream of the rectifier device 14, configured to transform in the electrical energy supplied by the latter into electrical energy having the desired voltage and current values.

The transformer 16 can be for example a high voltage/medium voltage (HV/MV) transformer, or a medium voltage/medium voltage (MV/MV) transformer and comprise a transformer primary 17 magnetically coupled to at least one transformer secondary 18.

The transformer 16, the rectifier device 14, the power converter 15 and the electric furnace 11 are connected to each other by respective connection circuits 21, 22, 23, 24 which, as a whole, define a power supply line 25.

The rectifier device 14 can be, for example, a diode bridge or a thyristor bridge, and comprise devices selected from Diodes, SCR (Silicon Controlled Rectifier), GTO (Gate Turn-Off thyristor), IGCT (Integrated Gate-Commutated Thyristor), MCT (Metal-Oxide Semiconductor Controlled Thyristor), BJT (Bipolar Junction Transistor), MOSFET (Metal-Oxide Semiconductor Field-Effect Transistor), IGBT (Insulated-Gate Bipolar Transistor) and SiC (Silicon Carbide Device).

The power converter 15 can be embodied as an electronic splitter, also known in the field as a “chopper”.

The power converter 15 comprises an electronic switch 26, which can be selectively commanded to open and close a direct current connection circuit, or DC-link 38, between the rectifier device 14 and the electric furnace 11, as well as a recirculation diode 27 connected in series to the electronic switch 16 and in anti-parallel to the electric furnace 11.

The switch 26 can for example be selected from a thyristor or a transistor, for example GTO (Gate Turn-Off thyristor), IGCT (Integrated Gate-Commutated Thyristor), MCT (Metal-Oxide Semiconductor Controlled Thyristor), BJT (Bipolar Junction Transistor), MOSFET (Metal-Oxide Semiconductor Field-Effect Transistor), IGBT (Insulated-Gate Bipolar Transistor).

By appropriately adjusting the duration of the opening intervals, that is, the interdiction intervals Ton, and of the closing interval, that is, the conduction interval Toff, of the switch 26, it is possible to define the electric voltage Vo transmitted to the electric furnace 11.

In particular, the regulation of the electric voltage Vo supplied to the load, in this specific case the electric furnace 11, can be obtained by keeping fixed a commutation period T given by the sum of the conduction interval Ton and the interdiction interval Toff, and by varying the conduction time Ton. Alternatively, it is possible to keep the conduction interval Ton constant and vary the commutation period T.

In both cases, an average voltage value Vm is obtained which is a fraction of the value of the input electric voltage Vin to the power converter 15.

In particular, the average value Vm can be calculated with the following formula: Vm=Vin*(Ton/T).

When the switch 26 is conducting, the current can pass through it and the electric furnace 11 is powered with the voltage Vin; when instead the switch 26 is interdicted, the current circulating in the circuit closes through the diode 27 in anti-parallel, until the next commutation of the electronic switch 26.

The power converter 15 can also comprise a capacitor 28, connected in parallel to the rectifier device 14 downstream of the series of the switch 26 and of the diode 27, and an inductor 29 connected on one side to the electric furnace 11 and on the other side in a node between the electronic switch 26 and the diode 27.

According to one aspect of the present invention, at least one input 23 or output 24 connection circuit of the power converter 15 comprises at least one segment of electrical line 30, 31, 32, 33 made with superconductor cables.

According to some embodiments, at least the segments of line 30, 31 of the input connection circuit 23 are made with superconductor cables.

According to some embodiments, which can be combined with the previous ones, at least the segments of line 32, 33 of the output connection circuit 24 are made with superconductor cables.

According to preferred embodiments, all the segments of line 30, 31, 32, 33, of the input 23 and output 24 connection circuits are made with superconductor cables.

These superconductor cables are characterized by having extremely smaller cross-section sizes, as well as generating practically zero losses in direct current DC.

For example, such superconductor cables can be at least partly made of magnesium diboride, or other alloys developed to create the superconduction. The cross-sections of the superconductor cables are very small compared to the sections of copper conductor cables used in the sector; therefore, with the same section, a superconductor cable transfers much more current than a traditional cable.

For example, in the sizing of power cables, capacity ranges from about 1.5 A/mm² for copper to about 1000 A/mm² for DC superconductor cables.

In order to function properly, the superconductor cables of the various segments of line 30, 31, 32, 33 are preferably cooled in a forced manner, for example using a cryogenic cooling unit 37, suitably positioned in the electric power supply apparatus 10.

The cooling medium, for example in the case of superconductors of magnesium diboride, is normally helium. However, other gases are conceivable, depending on the type of material the superconductor cables consist of, such as oxygen, nitrogen, hydrogen and/or their combinations.

Preferably, the segments of line 30, 31, 32, 33 made with one or more superconductor cables are forcedly cooled down to temperatures of 20-30 k (−240° C.). This in fact brings the resistance of the segment of line 30, 31, 32, 33 in direct current DC to negligible values, allowing a privileged passage of enormous quantities of electrons and therefore the transfer of high quantities of current.

This cooling can be carried out, for example, by means of a coaxial coating of the segments of line 30, 31, 32, 33, which is traversed by refrigerant fluids, such as for example liquid gases, such as nitrogen or helium, which can be made with an additional simple or corrugated steel tube.

The superconductor cables that make up these segments of line 30, 31, 32, 33 can be more or less rigid, so as to also allow rectilinear or curved underground installations.

Thanks to the use of a superconductor cable to create at least part of the connection circuit(s) 23, 24, it is possible to distance the connection point to the electricity grid 12A and the electric furnace 11 from each other with substantially zero, or in any case negligible, losses.

The use of superconductor cables, in particular, allows to increase the distances, generally comprised between a few meters up to about 20-40 m in traditional plants, between the connection means 13 for connection to the electricity grid 12A and the electric furnace 11, up to a few hundred meters, or even a few kilometers, as a function of the different requirements of the plant, for example expansion, addition or separation of components or parts, or other.

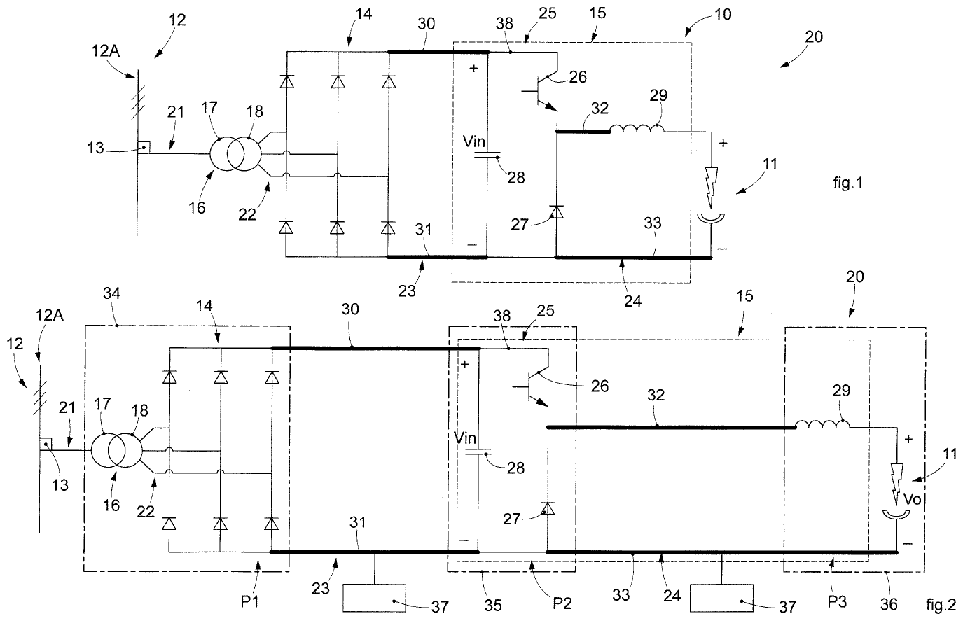

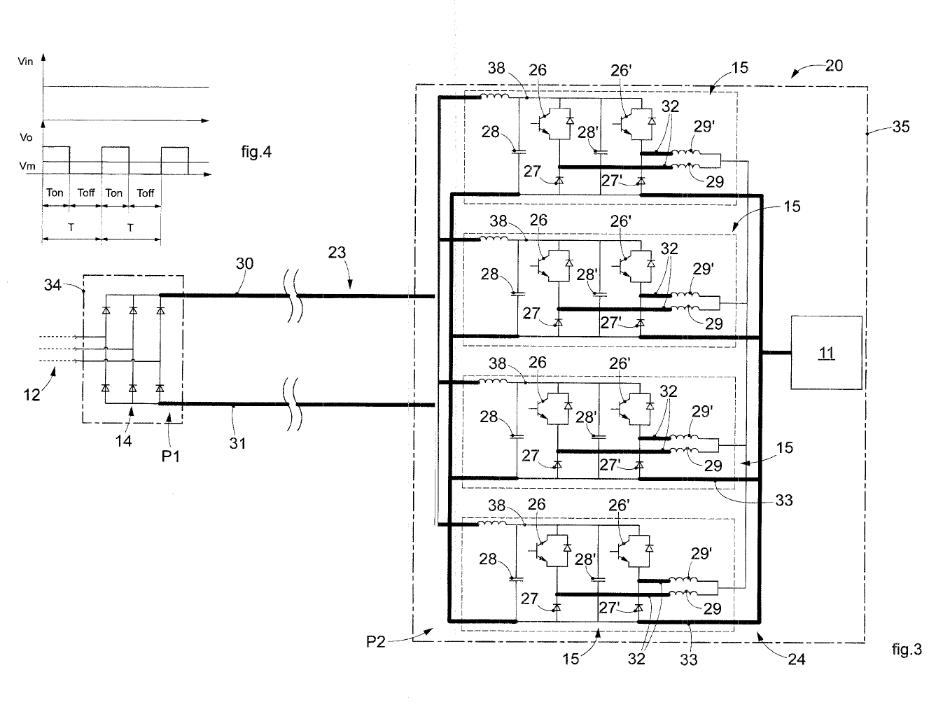

According to embodiments described with reference to FIGS. 2 and 3, it can be provided that a first part P1 of the electric power supply apparatus 10 is positioned inside a first building 34, or in a first installation site, and at least a second part P2 of the electric power supply apparatus 10 is positioned inside a second building 35, or in a second installation site. The two parts P1, P2 being connected to each other by means of segments of line 30, 31, 32, 33 made with superconductor cables.

According to some embodiments, described with reference to FIG. 2, the first part P1 comprises, for example, the transformer 16 and the rectifier device 14, while the second part P2 comprises at least part of the power converter 15 and possibly the electric furnace 11.

The first part P1 and the second part P2 can also be installed in buildings 34, 35 or in installation sites even tens or hundreds of meters away from each other, or even a few kilometers.

According to other embodiments, it can be provided that the power converter 15 and the electric furnace 11 are both installed in a same building 35, or in any case in proximity to each other in a same installation site (FIG. 3).

According to possible variants, the power converter 15 and the electric furnace 11 can be installed in different buildings 35, 36 separated from each other; in this case, it can be provided that the inductor 29 of the power converter 15, defining a third part P3 of the power supply apparatus 10, is disposed in the same building 36, or site, of the electric furnace 11.

According to other embodiments, for example described with reference to FIG. 3, the electric power supply apparatus 10 can comprise a plurality of power converters 15, in particular made as splitter devices, connected in parallel to each other between the rectifier device 14 and the electric furnace 11.

Furthermore, it can also be provided that each power converter 15 comprises two or more pairs of switch devices 26, 26′ and respective diodes 27, 27′ connected in parallel. Each pair can be connected to respective input capacitors 28, 28′ and output inductors 29, 29′.

Thanks to the modular configuration, given by the plurality of power converters 15, there is obtained, on the one hand, a redundancy which increases the reliability of the electric power supply apparatus 10, in particular as regards the electronic switches 16 subjected to high frequency commutations, and on the other hand, a reduction of the harmonics generated by commutations. By way of example, the number of power converters 15 can be such as to obtain a configuration of 24, 48, 64 pulses or more, progressively reducing the harmonic content.

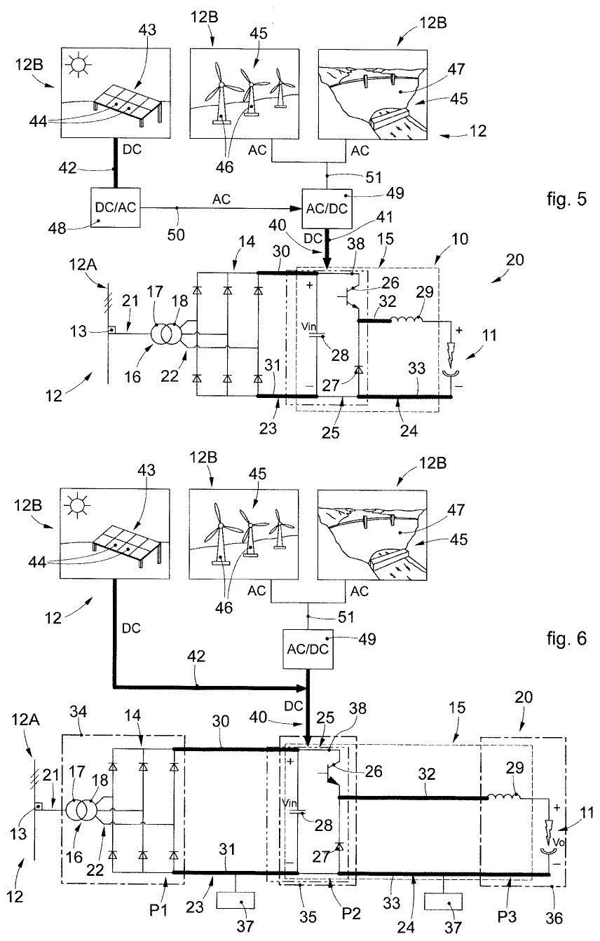

According to other embodiments, shown by way of example in FIGS. 5 and 6, which can be combined with the embodiments previously described, the electrical energy supply means 12 comprise at least one source of alternative energy 12B, preferably of the renewable type, different and independent from the electricity grid 12A.

The source of alternative energy 12B is configured to supply supply energy to the user device 11 in addition, or as an alternative, to the electrical energy supplied by the supply electricity grid 12A.

There can also be provided several sources of alternative energy 12B, of different or identical types, installed at a common site, or at different sites.

According to some embodiments, the at least one source of alternative energy 12B is separated from the electricity grid 12A and is connected directly to the user device 11, that is, it supplies energy to the latter without interacting with the electricity grid 12A and therefore without passing through the connection means 13 for connection therewith.

According to preferred embodiments, the source of alternative energy 12B is a source of renewable energy, for example solar, wind, or hydroelectric.

According to some variants, the source of alternative energy 12B is a source of energy of the non-renewable type, for example deriving from the combustion of fossil fuels, such as oil, coal, or gas.

In this case, the power converter 15 can comprise an alternative input connection circuit 40 connected to the source of alternative energy 12B.

Such alternative input connection circuit 40 comprises at least one segment of electrical line 41, 42 made with superconductor cables.

This allows to position the source of alternative energy 12B even very far from the steel plant 20, that is, hundreds of meters, even up to a few tens of kilometers, and to transfer the electrical energy with substantially negligible losses, in particular in direct current.

The source of alternative energy 12B is preferably connected to the static converter downstream of the electronic switch 26, in correspondence with the DC-link 38.

According to some embodiments, the at least one source of alternative energy 12B comprises at least one source of electrical energy in direct current 43 configured to supply direct electric voltage and current DC.

According to possible solutions, the source of electrical energy in direct current 43 comprises a plurality of photovoltaic panels 44 suitable to convert solar energy into electrical energy.

According to embodiments described with reference to FIG. 6, the source of electrical energy in direct current 43 can be directly connected to the power converter 15, in particular in a direct current circuit, or DC-link 38, upstream of the switch 26.

At least one segment of line 41, 42 between the source of electrical energy in direct current 43 and the power converter 15 can be made with superconductor cables as a function of the distance between the source of alternative energy 12B and the power converter 15.

According to some embodiments, the entire segment of line 41, 42 between the source of alternative energy in direct current 12B and the converter device 15 can be made with superconductor cables.

According to one possible variant, in the event that at least one segment of the connection line 50 is made with a cable of the traditional type, in order to limit losses, this can be configured to transport alternating electric current and there can be provided respective converter devices 48, 49 located upstream and downstream of the segment of line 50 in order to convert electric current from direct to alternating, and from alternating to direct.

In particular, a DC/AC converter 48 can be located upstream of the segment of line 50 in alternating current, preferably in proximity to the source of electrical energy in direct current 43, and an AC/DC converter 49 can be located downstream of this segment of line 50.

At least in the event that the segment of line 41 between the AC/DC converter 49 and the power converter 15 is made with a traditional cable, the AC/DC converter 49 can be disposed in proximity to the power converter 15.

According to some embodiments, the segment of line 41 between the AC/DC converter 49 and the power converter 15 can be made with a superconductor cable.

According to some embodiments, the at least one source of alternative energy 12B comprises at least one source of electrical energy in alternating current 45 configured to supply alternating electric voltage and current AC.

The source of electrical energy in alternating current 45 can comprise a wind power plant having at least one wind turbine 46 suitable to convert wind energy into electrical energy. According to some example embodiments, twenty or more wind turbines 46 can be provided, each one suitable to supply an electric power of about 5 MW, so as to be able to substantially power the electric furnace 11 only by means of the energy supplied by the source of alternative energy 12B, at least when it is in operation.

According to other variants, the source of electrical energy in alternating current 45 can comprise a hydroelectric power station, or a dam 47, suitable to convert hydroelectric energy into electrical energy.

In the case of sources of electrical energy in alternating current 45, an AC/DC converter 49 can be provided to convert it into energy in direct current. The latter can be connected to the source of electrical energy in alternating current with a segment of line 51, for example made with a traditional cable, and to the power converter 15 by means of a segment of line 41 made with a traditional cable, or with a superconductor cable, depending on the distance between them.

According to some embodiments, not shown, it can be provided that even only one or more sources of alternative energy 12B are present, without any connection to an electricity grid 12A of the traditional type.

Also according to these variants, a plurality of power converters 15 can be provided, connected in parallel to each other between the input connection circuit 40 and the user device 11.

It is clear that modifications and/or additions of parts may be made to the electric power supply apparatus 10 as described heretofore, without departing from the field and scope of the present invention as defined by the claims.

In the following claims, the sole purpose of the references in brackets is to facilitate reading and they must not be considered as restrictive factors with regard to the field of protection claimed in the specific claims.

1. Electric power supply apparatus, for a direct current electric furnace, comprising:
electric power supply means supplying a supply voltage and a supply current and comprising an electricity grid configured to supply electrical energy in alternating current;
a rectifier device connected to the electricity grid configured to transform the electrical energy in alternating current into electrical energy in direct current; and
a static power converter connected between said rectifier device and said electric furnace and configured to transform a direct electric voltage into a direct electric voltage of a different value, said static power converter being connected to said rectifier device and to said electric power supply means by means of a respective input connection circuit and to said electric furnace by means of a respective output connection circuit wherein at least one of said input and/or output connection circuits of said power converter comprises at least one segment of line made with superconductor cables.

2. Electric power supply apparatus as in claim 1, wherein said rectifier device and said power converter are physically distanced one from the other and connected to each other by means of segments of line made with superconductor cables.

3. Electric power supply apparatus as in claim 1, wherein said power converter and said electric furnace are physically distanced from each other and connected to each other by means of segments of line made with superconductor cables.

4. Electric power supply apparatus as in claim 1, further comprising a plurality of static power converters connected in parallel to each other between said electric power supply means and said electric furnace.

5. Electric power supply apparatus as in claim 4, wherein each static power converter comprises two or more pairs of switch devices and respective diodes connected in parallel, wherein each pair is connected to respective input capacitors and output inductors, wherein the segments of line which connect said pairs and said inductors are made with superconductor cables.

6. Electric power supply apparatus as in claim 1, wherein both the segments of line of said input connection circuit and the segments of line of said output connection circuit are made of superconductor cables.

7. Electric power supply apparatus as in claim 1, wherein at least a first part of said electric power supply apparatus is positioned inside a first building, or in a first installation site, and at least a second part of said electric power supply apparatus is positioned inside a second building, or in a second installation site, said parts being connected by means of said one or more segments of line made with superconductor cables.

8. Electric power supply apparatus as in claim 7, wherein said first part positioned in the first building comprises said rectifier device and possibly a transformer connected upstream of said rectifier device, and said second part positioned in the second building comprises said power converters and at least part of said output connection circuit which connects to said electric furnace.

9. Electric power supply apparatus as in claim 1, wherein said electric power supply means comprise at least one source of alternative energy.

10. Electric power supply apparatus as in claim 9, wherein said at least one source of alternative energy is connected in a direct current circuit, or DC-link of said power converter upstream of a switch device of the latter.

11. Electric power supply apparatus as in claim 1, wherein said superconductor cables which create said segments of line comprise a coaxial coating made by means of a simple, or corrugated, tube into which a refrigerant fluid, selected from liquid gases such as nitrogen or helium, is introduced.

12. Electric power supply apparatus as in claim 1, wherein said one or more superconductor cables are at least partly made of magnesium diboride.

13. Steel plant comprising a direct current electric furnace and an electric power supply apparatus as in claim 1, connected between electric power supply means and said electric furnace and configured to power said electric furnace with direct voltage and current having predefined values.

14. Steel plant as in claim 14, further comprising cryogenic cooling units positioned in said power supply apparatus and configured to cool said one or more segments of line made with superconductor cables.
